(19) United States
(12) Patent Application Publication
(10) Pub. No.: US 2009/0297858 A1
(43) Pub. Date: Dec. 3, 2009

(54) MULTILAYER INSULATION FOR WIRE, CABLE OR OTHER CONDUCTIVE MATERIALS

(75) Inventors: DANNY E. GLENN, Circleville, OH (US); BRIAN C. AUMAN, Pickerington, OH (US); KUPPUSAMY KANAKARAJAN, Dublin, OH (US); PHILIP ROLAND LACOURT, Chillicothe, OH (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/128,689

(22) Filed: May 29, 2008

(51) Int. Cl. B32B 27/00

(52) U.S. Cl. 428/421

(57) ABSTRACT

The present disclosure relates to a multilayer insulation structure having superior abrasion resistance. The multilayer insulation structure has a first polyimide outer layer, a polyimide core layer and an optional second polyimide outer layer. The first and second polyimide outer layers contain a fluoropolymer micropowder. The first and second polyimide outer layers have a combined weight of from 10 to 80 weight % of the total weight of the multilayer insulation structure. The abrasion resistance of the multilayer insulation structure is from 1500 to 18300 scrape cycles. The multilayer insulation structure is useful as wire or cable insulation wrap.

### FIELD OF DISCLOSURE

The present disclosure relates generally to a multilayer insulating structure having superior abrasion resistance. More specifically, the multilayer insulating structures of the present disclosure have: i. a polyimide core layer; and ii. a fluoropolymer micropowder filled polyimide outer layer.

### BACKGROUND OF THE DISCLOSURE

Surface abrasion resistance is important for the longevity of conductor coatings. Current wire and cable insulation structures typically have many (in some cases five) layers to maximize desired properties. Friction wear is a growing concern as electrical conductors move to smaller, lighter, and thinner applications, particularly in the aircraft and aerospace industries.

U.S. Pat. No. 7,022,402 to Lacourt is directed to an asymmetric multi-layer insulative film comprising a layer of polyimide in combination with a high-temperature bonding layer of poly(tetrafluoroethylene-co-perfluoro[alkyl vinyl ether]). A need exists however for lighter weight insulation structures with improved abrasion resistance, while maintaining physical properties and good adhesion between layers.

### SUMMARY

The present disclosure relates to a multilayer insulation structure having superior abrasion resistance. The multilayer insulation structure has a first polyimide outer layer, a polyimide core layer and optionally a second polyimide outer layer. The first and second polyimide outer layers contain a fluoropolymer micropowder. The first and second polyimide outer layers have a combined weight equal or less than the weight of the core layer. This allows for lighter weight insulation structures having good abrasion resistance while maintaining physical and electrical properties such as Young's modulus and dielectric strength.

### DETAILED DESCRIPTION

The present disclosure is directed to a multilayer insulation structure having superior abrasion resistance comprising:

i. a first polyimide outer layer comprising a polyimide and a fluoropolymer micropowder; and

ii. a polyimide core layer having a top surface and a bottom surface wherein the polyimide core layer top surface is directly bonded to the first polyimide outer layer.

In some embodiments, the multilayer insulation structure further comprises a second polyimide outer layer being directly bonded to the polyimide core layer bottom surface, the second polyimide outer layer comprising a polyimide and a fluoropolymer micropowder. The multilayer insulation structure of the present disclosure has good abrasion resistance and is useful as wire or cable insulation wrap. The abrasion resistance of the multilayer insulation structure is from 1500 to 18300 scrape cycles.

### Polyimide Outer Layers

The present disclosure comprises a first polyimide outer layer. The first polyimide outer layer contains a polyimide present in the amount between and optionally including any two of the following percentages: 85, 86, 87, 88, 89, 90, 91, 92, 93, 94, 95, 96, 97, 98 and 99 weight %. In some embodiments, the multilayer insulation structure further comprises a second polyimide outer layer. The second polyimide outer layer contains a polyimide present in the amount between and optionally including any two of the following percentages: 85, 86, 87, 88, 89, 90, 91, 92, 93, 94, 95, 96, 97, 98 and 99 weight %. In some embodiments, the first polyimide outer layer and second polyimide outer layer are the same material. In some embodiments, they are different materials. In some embodiments, the polyimide outer layers are derived from at least one aromatic dianhydride, at least one aromatic diamine, and optionally at least one aliphatic diamine. In some embodiments, the amount of aromatic diamine, aromatic dianhydride and aliphatic diamine are tailored to provide desired properties.

In some embodiments, the first polyimide outer layer and the second polyimide outer layer aromatic dianhydride are independently selected from the group consisting of pyromellitic dianhydride, 3,3′,4,4′-biphenyl tetracarboxylic dianhydride, 3,3′,4,4′-benzophenone tetracarboxylic dianhydride, 4,4′-oxydiphthalic dianhydride, 3,3′,4,4′-diphenylsulfone tetracarboxylic dianhydride, 2,2′-bis-(3,4-dicarboxyphenyl) hexafluoropropane dianhydride and mixtures thereof. In some embodiments, the first polyimide outer layer and the second polyimide outer layer aromatic diamine are independently selected from is selected from the group consisting of 3,4′-oxydianiline, 4,4′-oxydianiline, 3,3′-oxydianiline, meta-phenylenediamine, para-phenylenediamine, 1,3-bis(4-aminophenoxy) benzene and mixtures thereof. In some embodiments, the aliphatic diamine is hexamethylene diamine.

The first polyimide outer layer and the optional second polyimide outer layer contain a fluoropolymer micropowder. There is a practical limit to the amount of fluoropolymer micropowder used. Typically when filler loading levels increase, the physical and electrical properties can deteriorate and the bond strength between layers can decrease. The fluoropolymer micropowder is present in the amount between and optionally including any two of the following percentages: 1, 2, 3, 4, 5, 6, 7, 8, 9, 10, 11, 12, 13, 14, and 15 weight % fluoropolymer micropowder. For purposes of the present disclosure, the term fluoropolymer is intended to mean any polymer having at least one, if not more, fluorine atoms contained within the repeating unit of the polymer structure. The term fluoropolymer is also intended to mean a fluoropolymer resin and the terms may be used interchangeably (i.e. a fluoro-resin).

The term micropowder is intended to mean particles having an average particle size in at least one dimension between and including any two of the following sizes (in microns): 20, 18, 16, 14, 12, 10, 9, 8, 7, 6, 5, 4, 3, 2, 1, 0.8, 0.6, 0.5, 0.4, 0.3, 0.2, 0.1, 0.08, 0.06, 0.04 and 0.02 microns. In some embodiments, the fluoropolymer may be converted to micropowders by milling the resin in a hammer mill, or by using other mechanical means for reducing particle size. In one embodiment, the fluoropolymer resin is cooled, such as with solidified carbon dioxide or liquid nitrogen, prior to grinding or other mechanical manipulation to decrease particle size. In some embodiments, sieving may also be necessary, such as by sieving pulverized fluoropolymer resin through a 325-mesh screen (and optionally a 400-mesh screen filter) in order to obtain the desired particle size. In some embodiments, the fluoropolymer micropowder can be regularly or irregularly shaped and may have a smooth or rough surface texture. In some embodiments, fluoropolymer micropowders of different textures are used. In some embodiments, the fluoropolymer micropowder has portions of the surface that are smooth and other portions that are rough.

In one embodiment, the fluoropolymer micropowder is selected from polytetrafluoroethylene. In another embodiment, the fluoropolymer micropowder is polytetrafluoroethylene copolymer. In another embodiment, the fluoropolymer micropowder is selected from the group consisting of poly(tetrafluoroethylene-co-perfluoro[alkyl vinyl ether]), poly(tetrafluoroethylene-co-hexafluoropropylene), poly(ethylene-co-tetrafluoroethylene), chlorotrifluoroethylene polymer, tetrafluoroethylene chlorotrifluoroethylene copolymer, ethylene chlorotrifluoroethylene copolymer, polyvinylidene fluoride and mixtures thereof. The fluoropolymer may be a high molecular weight fluoropolymer or a low molecular weight fluoropolymer. In some embodiments, the fluoropolymer is low molecular weight fluoropolymer micropowder.

In some embodiments, the fluoropolymer is a polytetrafluoroethylene (PTFE), such as is available from E. I. du Pont de Nemours and Company of Wilmington, Del., USA, under the commercial name of TEFLON®. A PTFE fluoropolymer resin is sold under the brand name ZONYL MP® by DuPont, having a particle size in the range of about 20 nanometers to 100 microns and an average particle size from 1 to 15 microns. Such a resin can be converted to a micro powder by additional particle size reduction or sieving.

The fluoropolymer micropowder provides wear resistance, thus improving the abrasion resistance of the multilayer insulation structure. One advantage of having the fluoropolymer in only the outer layers of the multilayer insulation structure is the overall weight of the multilayer insulation structure is reduced. In some embodiments, the first polyimide outer layer and the second polyimide outer layer have a combined weight present in the amount between and optionally including any two of the following percentages: 10, 15, 20, 25, 30, 35, 40, 45, 50, 55, 60, 65, 70, 75 and 80 weight % of the total weight of the multilayer insulation structure. One advantage of using a fluoropolymer micropowder over a fluoropolymer film is good adhesion between layers. Another advantage is higher strength of the fluoropolymer micropowder polyimide composite layers compared to a polytetrafluoroethylene film. Thus, having the fluoropolymer micropowder in only the polyimide outer layers, provides good physical properties, adhesion between layers, electrical properties can be maintained while providing good abrasion resistance and a lighter weight insulation structure. The polyimide outer layers will generally provide scrape abrasion resistance, chemical resistance and thermal durability when the multilayer insulation structure is wrapped about a wire or cable or the like.

The first polyimide outer layer and the second polyimide outer layer are generally derived from a polyamic acid precursor. The polyamic acid precursor can comprise conventional (or non-conventional) catalysts and/or dehydrating agent(s). Methods for converting polyamic acids into polyimide are well known in the art and their preparation need not be discussed in detail here. Any conventional or non-conventional method for manufacturing polyimide film can be used to manufacture the first polyimide outer layer and the second polyimide outer layer of the present disclosure. In one embodiment, the fluoropolymer micro-powder component and polyimide precursor (i.e. the polyamic acid solution) are initially combined and subjected to sufficient shear and temperature to eliminate or otherwise minimize unwanted fluoropolymer micropowder agglomeration, thereby dispersing the fluoropolymer component into the polyamic acid component. The polyamic acid can then be processed according to traditional methods (for processing polyamic acid solutions into polyimides, particularly polyimide films).

### Polyimide Core Layer

The present disclosure comprises a polyimide core layer. The polyimide core layer is a dielectric layer with mechanical toughness and dielectric strength at high temperatures. The polyimide core layer has a top surface and a bottom surface. The polyimide core layer top surface is directly bonded to the first polyimide outer layer. In some embodiments, the polyimide core layer bottom surface is directly bonded to the second polyimide outer layer. In some embodiments, the polyimide core layer may be the same polyimide as first polyimide outer layer. In another embodiment, the polyimide core layer may be the same polyimide as optional second polyimide outer layer. In another embodiment, all three layers may comprise the same polyimide. In another embodiment, the polyimide core layer may comprise a polyimide different from the polyimide outer layers.

The polyimide core layer comprises at least one aromatic dianhydride and at least one aromatic diamine. In some embodiments, the polyimide core layer aromatic dianhydride is selected from the group consisting of pyromellitic dianhydride, 3,3′,4,4′-biphenyltetracarboxylic dianhydride, 3,3′,4,4′-benzophenone tetracarboxylic dianhydride, 4,4′-oxydiphthalic dianhydride, 3,3′,4,4′-diphenylsulfone tetracarboxylic dianhydride, 2,2′-bis-(3,4-dicarboxyphenyl) hexafluoropropane dianhydride and mixtures thereof. In some embodiments, the polyimide core layer aromatic diamine is selected from the group consisting of 3,4′-oxydianiline, 4,4′-oxydianiline, 3,3′-oxydianiline, meta-phenylenediamine, para-phenylenediamine and mixtures thereof. In some embodiments, the polyimide core layer may comprise additives commonly known in the art so long as they do not negatively impact the desired balance of mechanical, electrical properties, and weight of the multilayer insulation structure. In some embodiments, the polyimide core layer comprises from 50 to 100% wt polyimide.

The polyimide core layer is generally derived from a polyamic acid precursor. The polyamic acid precursor can comprise conventional (or non-conventional) catalysts and/or dehydrating agent(s). Methods for converting polyamic acids into polyimide are well known in the art and their preparation need not be discussed here. Any conventional or non-conventional method for manufacturing polyimide film can be used to manufacture the core layer of the present disclosure. The polyimide core layer is from 20 to 90 weight % of the total multilayer insulation structure,

### Multilayer Insulation Structure

For purposes of this disclosure the term “film” herein denotes a free standing film or a coating on a substrate. The term “film” is used interchangeably with the term “layer” and refers to a covering a desired area. In some embodiments, films and layers can be formed by any conventional deposition technique, vapor deposition, liquid deposition (continuous and discontinuous techniques), and thermal transfer. Continuous deposition techniques include but are not limited to, gravure coating, curtain coating, dip coating, slot-die coating, spray coating, continuous nozzle coating and extrusion. Discontinuous deposition techniques include, but are not limited to, spin coating, ink jet printing, gravure printing, and screen printing. In some embodiments, the multilayer insulation structure is produced by coextrusion or sequential coating.

In some embodiments, the multilayer insulation structure is useful as wire or cable insulation wrap. In some embodiments, the multilayer insulation structure is useful for supporting, insulating and/or protecting electrically conductive materials, particularly: (i.) wires (or cables) in aerospace, high voltage machinery or other high performance (electrical) insulation type applications; and/or (ii.) electronic circuitry in high speed digital or similar type applications. The multilayer insulation structure is particularly well suited for wire and cable insulation wrap in the aerospace industry due to lighter weight, improved abrasion resistance while maintaining good physical properties and good adhesion between layers.

The abrasion resistance of the present disclosure is determined by the number of scrape cycles until failure. Failure is reached once the scrape abrasion blade reaches/cuts through the film wrap completing an electrical path simulating an electrical failure The abrasion resistance of the multilayer insulation structure is between and optionally including any two of the following: 1500, 1581, 2000, 2284, 4000, 6000, 8000, 10000, 12000, 14000, 16000, 18000, 18252 and 18300 scrape cycles. The multilayer insulation structure has a Young's modulus between and optionally including any two of the following: 300, 400, 500, 600, 700, 750, 762, 800, 850, 875, 900, 918, 950, 969, 1000, 1100, 1139, 1150, 1200, 1300, 1400, and 1500 Kpsi.

The Dielectric Breakdown Voltage (Dielectric Strength) is a value of the maximum voltage reached during voltage ramping when the film fails/shorts. The multilayer insulation structure in accordance with the present disclosure has a dielectric strength between and optionally including any two of the following: 4700, 4706, 4800, 4900, 5000, 5200, 5400, 5600, 5800, 6000, 6200, 6400, 6553 and 6600, 6800, 7000, 7200, 7400, 7800, and 8000 volts/mil.

### Forming an Electrically Insulative Tape and Wrapping a Wire or Conductor:

The multilayer insulation structure of the present disclosure is generally useful for electrical insulation purposes. The structures can be slit into narrow widths to provide tapes. These tapes can then be wound around an electrical conductor in spiral fashion or in an overlapped fashion. The amount of overlap can vary, depending upon the angle of the wrap. The tension employed during the wrapping operation can also vary widely, ranging from just enough tension to prevent wrinkling, to a tension high enough to stretch and neck down the tape.

Even when the tension is low, a snug wrap is possible since the tape will often shrink under the influence of heat during any ensuing heat-sealing operation. Heat-sealing of the tape can be accomplished by treating the tape-wrapped conductor at a temperature and time sufficient to fuse the high-temperature bonding layer to the other layers in the composite. In some embodiments, the heat-sealing temperature required ranges generally from 200, 225, 240, 250, 275, 300, 325 or 350° C. to 375, 400, 425, 450, 475 or 500° C., depending upon the insulation thickness, the gauge of the metal conductor, the speed of the production line and the length of the sealing oven. In one embodiment, the wire wrapped with the multilayer insulation structure of the present disclosure is cured in an oven at 400° C. for one minute.

As used herein, the terms “comprises,” “comprising,” “includes,” “including,” “has,” “having” or any other variation thereof, are intended to cover a non-exclusive inclusion. For example, a method, process, article, or apparatus that comprises a list of elements is not necessarily limited only those elements but may include other elements not expressly listed or inherent to such method, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

### EXAMPLES

The advantages of the present invention are illustrated in the following examples which do not limit the scope of the claims. Preparation of compositions, processing and test procedures used in the examples of the present invention are described below.

### Dispersion Process

A dispersion is accomplished by mixing 5-15% (by weight) Zonyl® MP1150 (Teflon® Micro-Powder) into 15-20% solids polyamic acid solution having excess amine ends using a Silverson L4RT-A High Shear Mixing at approximately 4000-8000 rpm for approximately 5 minutes or until filler is well dispersed. Filler dispersion may be checked by Particle Size Analysis (Horiba) scattering light analyzer or other particle size analyzer per availability.

### Polymer Finishing

6% finishing solution (6% PMDA in DMAC solvent, by weight) added in incremental steps to increase the molecular weight of the filled polyamic acid solution sample finished to achieve desired target viscosity. Target viscosity varied depending on multiple layer construction. Bottom (unfilled/core) layer usually finished to 1500-2000 Poise and top surface (filled) layer finished to 600-1000 Poise.

### Film Sheet Casting and Curing

Spreading approximately 100 grams of finished polymer of target viscosity across one end of the glass plate and drawing down (pulling) with the 0.5 inch diameter die rod creating a thin sheet approximately 0.5-1.5 MIL thick. This step can be repeated with additional polymer coatings to create multiple layers of film. The glass plate with polyamic acid coating is then placed onto a hotplate at a temperature of 80-100° C. for approximately 20-30 minutes (depending on sheet thickness) until the coating has dried to a green film state and then the film is cooled to room temperature, stripped from glass and mounted onto a pin frame for oven curing. The pin frame is then placed in an oven having a temperature of approximately 150° C. The oven temperature is increased to 300° C. for approximately 45 minutes, then finally curing at 400° C. for 5 minutes.

### Scrape Abrasion Testing

Film samples are prepared by cutting to a desired film width of 0.635 centimeters then wrapped onto conduit wire in a spiral repeating direction up to the desired test sample length. A 25% to 50% overlap of each spiral wrap around the wire is made to ensure 100% wire surface coverage. When the full length and wire area has been wrapped, the wire wrapped with test film is adhered/cured in a high temp oven for a complete seal of the wire conduit. Wrapped wire samples are then examined for scrape abrasion resistance on a Scrape Abrasion Tester a General Electric, Repeated Scrape Abrasion Tester, Cat. #158L238G1 rating 115 volts 60 cycles Industrial heating Department Shelbyville, Ind. An electrical current is applied to the copper wire conduit and a scrape abrasion blade is dragged across the film wrap surface in a repeating back and forth motion until failure or cut through is reached. Failure is reached once the scrape abrasion blade reaches/cuts to the film wrap completing an electrical path simulating an electrical failure. The wire is a 12 (American Wire Gauge) solid copper wire. The abrasion resistance values were determined. The condition for fusing the insulation structure to the copper wire is 400° C. for 1 minute for single layer samples.

The condition for fusing the insulation structure to the copper wire is 400° C. for 3 minute for co-cast film samples.

### Dielectric Strength

An AC Voltage Dielectric Strength Tester is used to measure film Dielectric Breakdown or Dielectric Strength. Continuous voltage is applied to the film until the maximum voltage or point where a short/failure occurs (film charring or burn through). Ramping rates of approximately 400 to 800 volts AC per second (voltage ramping rate is adjustable) are applied until failure. Film samples are cut to approximately 25.4 cm by 25.4 cm sheets. Ten breakdown voltage measurements are collected and the average value of ten measurements is reported (Volts/mil).

### Equipment Information:

Beckman Industrial Corporation

Cedar Grove operations

Cedar Grove, N.J. 07009

Model: PA7-502/102

Serial No: 171

Line Input: 117 VAC

Power: 2 KVAC

Hertz: 60

### Young's Modulus

An Instron Series 1102 unit was used to measure the young's modulus for all film sample formulations. At least five tensile test samples are made and measured. The average value of five measurements is reported. CRL Test method 03:5207 is used and is based on ASTM D882.

### Equipment Information:

Instron Series 1102

Load Cell: 250 lbs maximum

Sample Information:

Specimen Width: 0.50 inches

Specimen Gage Length: 4.00 inches

Specimen Crosshead Speed: 2.00 inches/min

### Example 1

EXAMPLE 1 illustrates the use of a co-cast multilayer insulation structure having a polyimide layer of PMDA, BPDA, 4,4′-ODA, PPD copolymer and a second polyimide layer of PMDA, BPDA, 4,4′-ODA, PPD containing 5% teflon micropowder. The co-cast multilayer insulation structure has a thickness ratio of 1:1 (polyimide fluoropolymer micropowder layer to polyimide layer). The sample is prepared as outlined above. The results are reported in Table 1.

### Example 2

EXAMPLE 2 illustrates the use of a co-cast multilayer insulation structure having a polyimide layer of PMDA, BPDA 4,4′-ODA PPD copolymer and a second polyimide layer of PMDA, BPDA 4,4′-ODA PPD containing 15 wt % teflon micropowder. The co-cast multilayer insulation structure has a thickness ratio of 1:1 (polyimide fluoropolymer micropowder layer to polyimide layer). The sample is prepared as outlined above. The results are reported in Table 1.

### Example 3

EXAMPLE 3 illustrates the use of a co-cast multilayer insulation structure having a polyimide layer of PMDA, BPDA 4,4′-ODA PPD copolymer and a second polyimide layer of PMDA, BPDA 4,4′-ODA PPD containing 5 wt % teflon micropowder. The co-cast multilayer insulation structure has a thickness ratio of 1:1 (polyimide fluoropolymer micropowder layer to polyimide layer). The sample is prepared as outlined above. The results are reported in Table 1.

### Example 4

EXAMPLE 4 illustrates the use of a co-cast multilayer insulation structure having a polyimide layer of PMDA, BPDA 4,4′-ODA PPD copolymer and a second polyimide layer of PMDA, BPDA 4,4′-ODA PPD containing 15 wt % teflon micropowder. The co-cast multilayer insulation structure has a thickness ratio of 2:1 (polyimide fluoropolymer micropowder layer to polyimide layer). The sample is prepared as outlined above. The results are reported in Table 1.

### Comparative Example 1

COMPARATIVE EXAMPLE 1 illustrates the use of a single layer of PMDA, BPDA, 4,4′-ODA PPD copolymer containing 5 wt % Zonyl® MP1150 teflon micropowder. The single layer sample is prepared as outlined above. The results are reported in Table 1.

### Comparative Example 2

COMPARATIVE EXAMPLE 2 illustrates the use of a single layer of PMDA, BPDA, 4,4′-ODA PPD copolymer containing 15 wt % Zonyl® MP1150 teflon micropowder. The single layer sample is prepared as outlined above. The results are reported in Table 1.

### Comparative Example 3

COMPARATIVE EXAMPLE 3 illustrates the use of a single layer of PMDA, BPDA, 4,4′-ODA PPD copolymer without filler. The single layer sample is prepared as outlined above without the described dispersion process. The results are reported in Table 1.

TABLE 1

| | | Abrasion | | | Thickness | |
|---|---|---|---|---|---|---|
| | | Resistance | | | (Ave of 10 | |
| | Thickness | (number of | Thickness | Young's | samples) | Dielectric |
| | (mils) | cycles) | (mils) | Modulus | (mils) | Strength |
| Example 1 | 1 | 1581 | 1.0 | 970 | 0.8 | 6553 |
| Example 2 | 1.1 | 2934 | 1.1 | 919 | 0.8 | 4706 |
| Example 3 | 1.1 | 3174 | | | | |
| Example 4 | 1.56 | 18252 | | | | |
| Wait for Ex | | | | | | |
| Comp. Ex. 1 | 0.9 | 159 | 0.9 | 894 | 1.0 | 4509 |
| Comp. Ex. 2 | 0.9 | 59 | 1.0 | 681 | 1.1 | 4057 |
| Comp. Ex 3 | 1 | 113 | | | | |

Note that not all of the activities described above in the general description or the examples are required, that a portion of a specific activity may not be required, and that further activities may be performed in addition to those described. Still further, the order in which each of the activities are listed are not necessarily the order in which they are performed. After reading this specification, skilled artisans will be capable of determining what activities can be used for their specific needs or desires.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense and all such modifications are intended to be included within the scope of the invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

When an amount, concentration, or other value or parameter is given as either a range, preferred range or a list of upper values and lower values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

What is claimed is:

1. A multilayer insulation structure having superior abrasion resistance comprising:
A. a first polyimide outer layer comprising;
i. 85 to 99 weight % polyimide derived from at least one aromatic dianhydride, at least one aromatic diamine, and optionally at least one aliphatic diamine,
ii. 1 to 15 weight % fluoropolymer micropowder;
B. a polyimide core layer having a top surface and a bottom surface wherein:
i. the polyimide core layer comprising at least one aromatic dianhydride and at least one aromatic diamine,
ii. the polyimide core layer is from 20 to 90 weight % of the total multilayer insulation structure,
iii. the polyimide core layer top surface is directly bonded to the first polyimide outer layer,
wherein the abrasion resistance of the multilayer insulation structure is from 1500 to 18300 scrape cycles.

2. The multilayer insulation structure in accordance with claim 1 further comprising a second polyimide outer layer being directly bonded to the polyimide core layer bottom surface, the second polyimide outer layer comprising;
i. 85 to 99 weight % polyimide derived from at least one aromatic dianhydride, at least one aromatic diamine, and optionally at least one aliphatic diamine,
ii. 1 to 15 weight % fluoropolymer micropowder; and
wherein the first polyimide outer layer and the second polyimide outer layer have a combined weight of from 10 to 80 weight % of the total weight of the multilayer insulation structure.

3. The multilayer insulation structure in accordance with claim 1 or 2 wherein the fluoropolymer micropowder is selected from polytetrafluoroethylene and copolymers thereof.

4. The multilayer insulation structure in accordance with claim 1 wherein the polyimide core layer aromatic dianhydride is selected from the group consisting of pyromellitic dianhydride, 3,3′,4,4′-biphenyltetracarboxylic dianhydride, 3,3′,4,4′-benzophenone tetracarboxylic dianhydride, 4,4′-oxydiphthalic dianhydride, 3,3′,4,4′-diphenylsulfone tetracarboxylic dianhydride, 2,2′-bis-(3,4-dicarboxyphenyl) hexafluoropropane dianhydride and mixtures thereof; and wherein the polyimide core layer aromatic diamine is selected from the group consisting of 3,4′-oxydianiline, 4,4′-oxydianiline, 3,3′-oxydianiline, meta-phenylenediamine, para-phenylenediamine and mixtures thereof.

5. The multilayer insulation structure in accordance with claim 1 or 2 wherein the first polyimide outer layer and the second polyimide outer layer aromatic dianhydride are independently selected from the group consisting of pyromellitic dianhydride, 3,3′,4,4′-biphenyltetracarboxylic dianhydride, 3,3′,4,4′-benzophenone tetracarboxylic dianhydride, 4,4′-oxydiphthalic dianhydride, 3,3′,4,4′-diphenylsulfone tetracarboxylic dianhydride, 2,2′-bis-(3,4-dicarboxyphenyl) hexafluoropropane dianhydride and mixtures thereof; and wherein the first polyimide outer layer and the second polyimide outer layer aromatic diamine are independently selected from the group consisting of 3,4′-oxydianiline, 4,4′-oxydianiline, 3,3′-oxydianiline, meta-phenylenediamine, para-phenylenediamine, 1,3-bis(4-aminophenoxy) benzene and mixtures thereof.

6. The multilayer insulation structure in accordance with claim 1 or 2 wherein the aliphatic diamine is hexamethylene diamine.

7. The multilayer insulation structure in accordance with claim 1 or 2 having a Young's modulus from 600 to 1500 KPSI.

8. The multilayer insulation structure in accordance with claim 1 or 2 having a dielectric strength from 4700 to 8000 volts/mil.

9. The multilayer insulation structure in accordance with claim 1 or 2 wherein the multilayer insulation structure is useful as wire or cable insulation wrap.
